(19) United States
(12) Patent Application Publication
(10) Pub. No.: US 2025/0110545 A1
(43) Pub. Date: Apr. 3, 2025

(54) ELECTRONIC DEVICES WITH LOW-POWER USER INTERFACE

(71) Applicant: Tyco Fire & Security GmbH, Neuhausen am Rheinfall (CH)

(72) Inventors: Daniel R. Hjortland, Milwaukee, WI (US); Christopher P. Brophy, Cedarburg, WI (US); Daniel J. Spacek, Cudahy, WI (US); Mansi Vasant Deshpande, Milwaukee, WI (US)

(73) Assignee: Tyco Fire & Security GmbH, Neuhausen am Rheinfall (CH)

(21) Appl. No.: 18/900,590

(22) Filed: Sep. 27, 2024

Related U.S. Application Data
(60) Provisional application No. 63/541,609, filed on Sep. 29, 2023.

(51) Int. Cl. G06F 1/3287; G06F 3/041; G06F 3/044

(52) U.S. Cl. CPC G06F 1/3287; G06F 3/0416; G06F 3/044

(57) ABSTRACT

A sensor device including a housing and a number of sensors. The sensor device includes a display configured to display one or more parameters representing the environmental condition in the building zone, a user interface configured to receive a user input, an auxiliary sensor coupled to the user interface and configured to detect movement of the user interface; and a control circuit communicably coupled to the plurality of sensor components, the display, the user interface, and the auxiliary sensor, wherein in response to a first user detection signal from the auxiliary sensor indicating movement of the user interface, the control circuit is structured to activate the user interface to receive a first user input

### CROSS-REFERENCE TO RELATED PATENT APPLICATIONS

This application claims the benefit of and priority to U.S. Provisional Application No. 63/541,609, filed on Sep. 29, 2023, the entire disclosure of which is incorporated by reference herein.

### BACKGROUND

The present application relates generally to the fields of electronic HVAC devices and accessories for electronic HVAC devices. The present application relates more specifically to an electronic device with a user interface configured to activate and deactivate based on an auxiliary sensor being triggered such that the user interface is deactivated when not in use, saving power.

As electronic HVAC equipment becomes smaller, faster, and more feature-laden, the demand for touch-based user interfaces to interact with the HVAC equipment has increased. However, the power required to continuously monitor a touch-based user interface makes incorporating the technology into battery-powered devices difficult. Accordingly, there is a need for a low-power user interface for an HVAC sensor device or thermostat that is configured to reduce the power demands of the touch-based user interface to accommodate the reduced power capabilities of battery-powered devices.

### SUMMARY

One implementation of the present disclosure includes a sensor device for use in a building zone. The sensor device includes a plurality of sensor components, a display, a user interface, an auxiliary sensor, and a control circuit. Each of the plurality of sensor components is configured to sense an environmental condition in the building zone. The display is configured to display one or more parameters representing the environmental condition in the building zone. The user interface is configured to receive a user input. The auxiliary sensor is coupled to the user interface and configured to detect movement of the user interface. The control circuit is communicably coupled to the plurality of sensor components, the display, the user interface, and the auxiliary sensor. In response to a first user detection signal from the auxiliary sensor, the control circuit is structured to activate the user interface to receive a first user input.

Another implementation of the present disclosure includes a building management system (BMS) including a user input device including a display configured to display one or more parameters representing the state or condition of the building; a user interface configured to receive a user input; an auxiliary sensor coupled to the user interface and configured to detect movement of the user interface; and a control circuit communicably coupled to the display, the user interface, and the auxiliary sensor, wherein in response to a first user detection signal from the auxiliary sensor indicating movement of the user interface, the control circuit is structured to activate the user interface to receive a first user input, wherein the control circuit is further configured to operate the building equipment according to the first user input.

Another implementation of the present disclosure includes a method including the steps of providing a sensor device comprising a user interface configured to receive a user input and an auxiliary sensor configured to detect a movement of the user interface; disabling the user interface; detecting, via the auxiliary sensor, a first user input based on movement from the user interface; enabling the user interface in response to the first user input; receiving, via the user interface, a second user input; and disabling the user interface, in response to not receiving a third user input from the auxiliary sensor within a predetermined time period.

### BRIEF DESCRIPTION OF THE DRAWINGS

Various objects, aspects, features, and advantages of the disclosure will become more apparent and better understood by referring to the detailed description taken in conjunction with the accompanying drawings, in which like reference characters identify corresponding elements throughout. In the drawings, like reference numbers generally indicate identical, functionally similar, and/or structurally similar elements.

FIG. 1 is a drawing of a building equipped with an HVAC system, according to an exemplary embodiment.

FIG. 2 is a diagram of a waterside system that may be used in conjunction with the building of FIG. 1, according to an exemplary embodiment.

FIG. 3 is a diagram of an airside system that may be used in conjunction with the building of FIG. 1, according to an exemplary embodiment.

FIG. 4 is a block diagram of a BMS system that may be used to control the HVAC system of FIG. 1, according to an exemplary embodiment.

FIG. 5 is a drawing of a thermostat with a selectively activated user interface that may be used to control the HVAC system of FIG. 1, according to an exemplary embodiment.

FIG. 6 is a schematic drawing of a building equipped with a residential heating and cooling system and the thermostat of FIG. 5, according to an exemplary embodiment.

FIG. 7 is a schematic drawing of the residential heating and cooling system of FIG. 6, according to an exemplary embodiment.

FIG. 8 is a block diagram of the thermostat of FIG. 5, according to an exemplary embodiment.

FIG. 9 is a flow diagram of a process for controlling the display of the thermostat of FIG. 5, according to an exemplary embodiment.

### DETAILED DESCRIPTION

Referring generally to the FIGURES, systems and methods for reducing the power consumption of a user interface of an electronic device are shown, according to exemplary embodiments. In a building, various zones may be defined where environmental conditions of each zone are controlled by building equipment or devices located in the zone or otherwise associated with the zone. For example, in a building, an air handler unit (AHU) may heat or cool air for the entire building, yet in each zone, an HVAC system of the building can regulate the environmental conditions within a zone based on signals from an electronic device such as a sensor device or thermostat within or associated with the zone.

The electronic device (i.e., control device, sensor device, thermostat, etc.) can control the HVAC system by sending electrical signals to the system and/or opening and/or closing switches. An electronic device can measure the environmental conditions of a zone (e.g., one or more rooms in the building) through one or more sensors and use the measurements to determine the deviation in the environmental conditions from a set point. The electronic device may also act as a local thermostat by receiving a user input and determining control signals to send to the HVAC system. For example, the set point of a zone can be configured by a user through an interface. An electronic device is typically fixed to a surface within the zone and wired for power and/or communication with the HVAC system. An electronic device may also wirelessly communicate with the HVAC system and rely on an internal power supply such as battery.

In some instances, these electronic devices include a user interface configured to receive the user input for controlling the environmental condition within the zone. The user interface may include a touch-based user interface such as a capacitive touch-sensitive panel. The user interface must be powered to receive a user input, however constantly powering the touch-based user interface can consume more power than desirable for wireless battery-powered systems.

In some embodiments herein, a sensor device and/or thermostat with a low-power user interface may selectively disable and enable the user-interface in response to signals from an auxiliary sensor. The auxiliary sensor consumes less power than the user-interface, such that the electronic device reduces its overall power consumption but selectively activating and deactivating the user interface. For example, a user interface may in a default state be disabled (e.g., unpowered or in a reduced power state). An accelerometer, or other type of sensor, may be coupled to the user interface and configured to detect an initial “tap” or input from a user on the user interface, which is not otherwise detected from the disabled user interface. In response to the detection from the accelerometer, the user interface may be enabled such that additional user inputs are detected by the user interface. Accordingly, a sensor device and/or thermostat can reduce the power consumption attributable to the user interface by disabling the user interface when no user is interacting with the sensor device and/or thermostat. Beneficially, this reduces the power requirements of the sensor device and/or thermostat and may allow for battery-powered applications to have longer operational lifespans before the batteries must be replaced or recharged.

### Building HVAC Systems and Building Management Systems

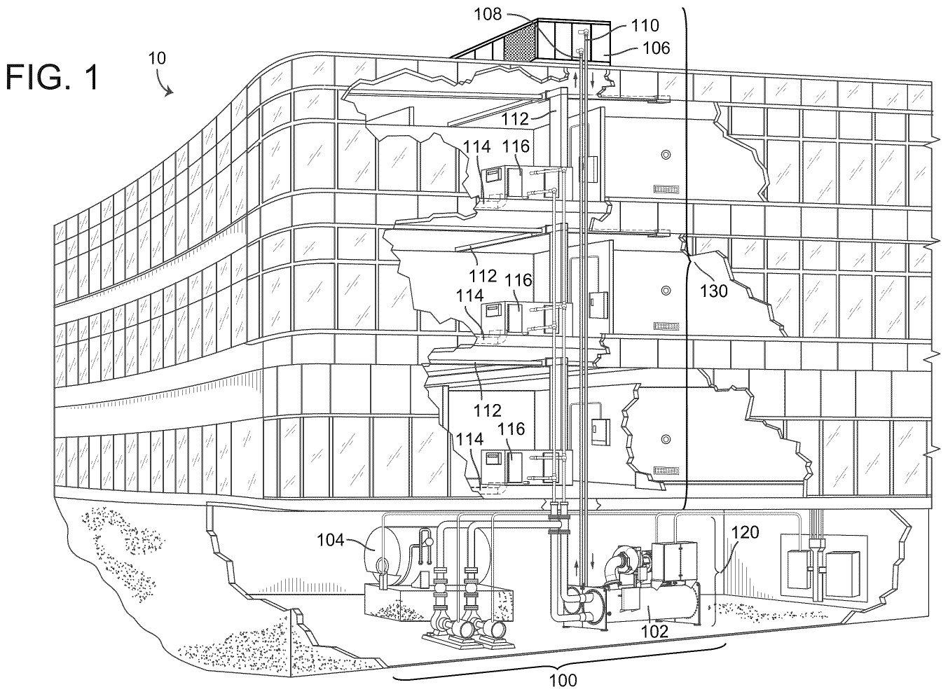

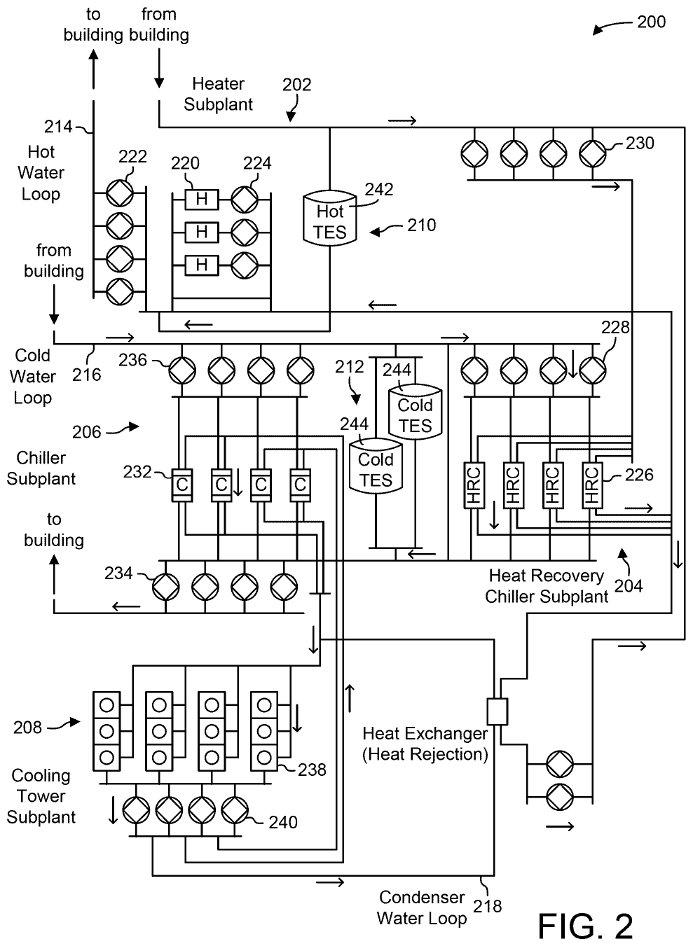

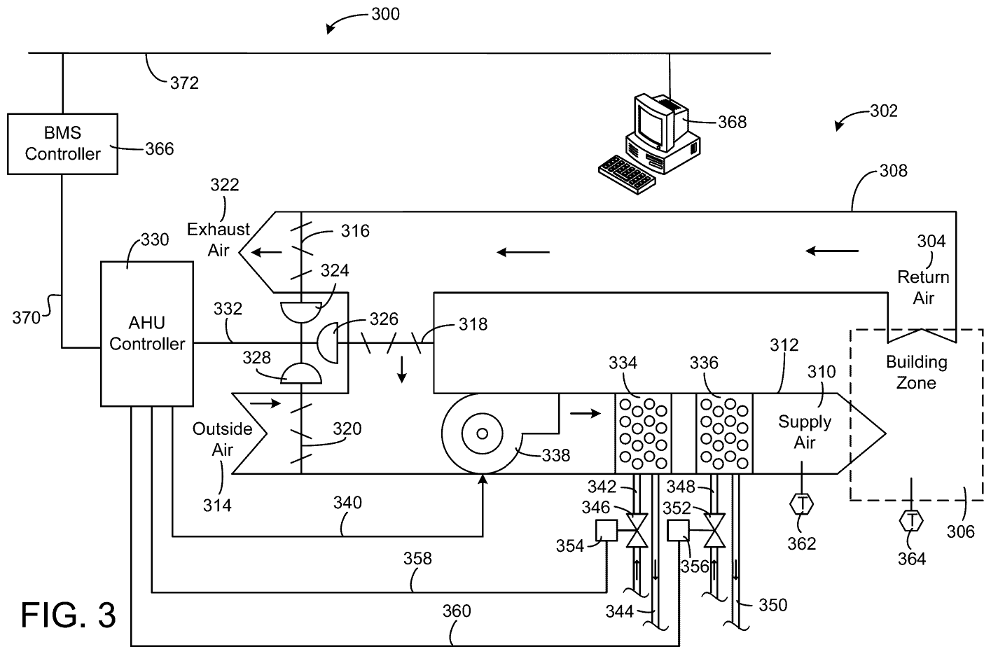

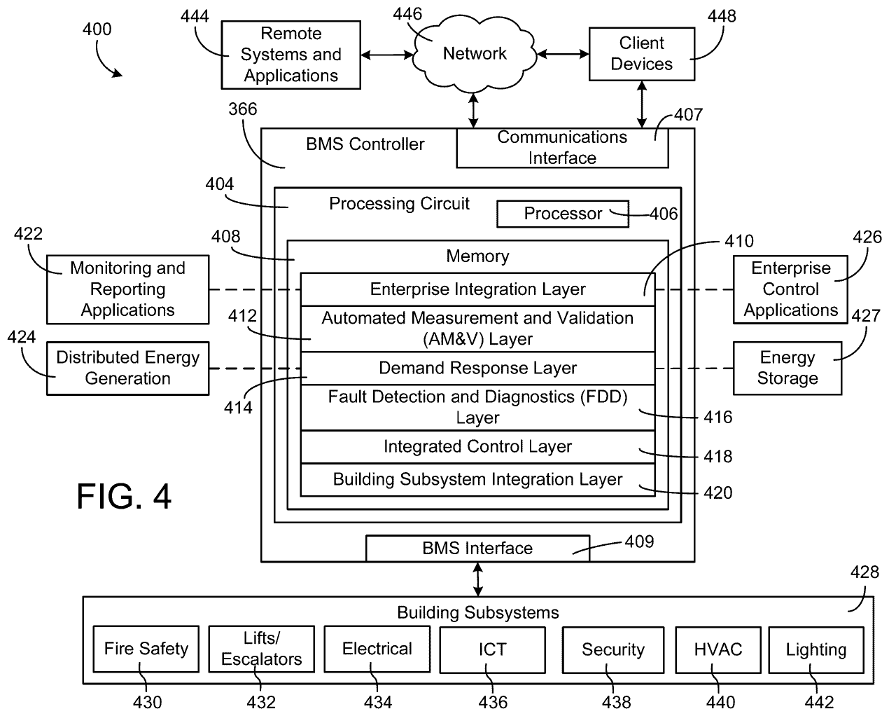

Referring now to FIGS. 1-4, several building management systems (BMS) and HVAC systems in which the systems and methods of the present disclosure can be implemented are shown, according to some embodiments. In brief overview, FIG. 1 shows a building 10 equipped with a HVAC system 100. FIG. 2 is a block diagram of a waterside system 200 which can be used to serve building 10. FIG. 3 is a block diagram of an airside system 300 which can be used to serve building 10. FIG. 4 is a block diagram of a BMS which can be used to monitor and control building 10.

### Building and HVAC System

Referring particularly to FIG. 1, a perspective view of a building 10 is shown. Building 10 is served by a BMS. A BMS is, in general, a system of devices configured to control, monitor, and manage equipment in or around a building or building area. A BMS can include, for example, a HVAC system, a security system, a lighting system, a fire alerting system, any other system that is capable of managing building functions or devices, or any combination thereof.

The BMS that serves building 10 includes a HVAC system 100. HVAC system 100 can include a plurality of HVAC devices (e.g., heaters, chillers, air handling units, pumps, fans, thermal energy storage, etc.) configured to provide heating, cooling, ventilation, or other services for building 10. For example, HVAC system 100 is shown to include a waterside system 120 and an airside system 130. Waterside system 120 may provide a heated or chilled fluid to an air handling unit of airside system 130. Airside system 130 may use the heated or chilled fluid to heat or cool an airflow provided to building 10. An exemplary waterside system and airside system which can be used in HVAC system 100 are described in greater detail with reference to FIGS. 2-3.

HVAC system 100 is shown to include a chiller 102, a boiler 104, and a rooftop air handling unit (AHU) 106. Waterside system 120 may use boiler 104 and chiller 102 to heat or cool a working fluid (e.g., water, glycol, etc.) and may circulate the working fluid to AHU 106. In various embodiments, the HVAC devices of waterside system 120 can be located in or around building 10 (as shown in FIG. 1) or at an offsite location such as a central plant (e.g., a chiller plant, a steam plant, a heat plant, etc.). The working fluid can be heated in boiler 104 or cooled in chiller 102, depending on whether heating or cooling is required in building 10. Boiler 104 may add heat to the circulated fluid, for example, by burning a combustible material (e.g., natural gas) or using an electric heating element. Chiller 102 may place the circulated fluid in a heat exchange relationship with another fluid (e.g., a refrigerant) in a heat exchanger (e.g., an evaporator) to absorb heat from the circulated fluid. The working fluid from chiller 102 and/or boiler 104 can be transported to AHU 106 via piping 108.

AHU 106 may place the working fluid in a heat exchange relationship with an airflow passing through AHU 106 (e.g., via one or more stages of cooling coils and/or heating coils). The airflow can be, for example, outside air, return air from within building 10, or a combination of both. AHU 106 may transfer heat between the airflow and the working fluid to provide heating or cooling for the airflow. For example, AHU 106 can include one or more fans or blowers configured to pass the airflow over or through a heat exchanger containing the working fluid. The working fluid may then return to chiller 102 or boiler 104 via piping 110.

Airside system 130 may deliver the airflow supplied by AHU 106 (i.e., the supply airflow) to building 10 via air supply ducts 112 and may provide return air from building 10 to AHU 106 via air return ducts 114. In some embodiments, airside system 130 includes multiple variable air volume (VAV) units 116. For example, airside system 130 is shown to include a separate VAV unit 116 on each floor or zone of building 10. VAV units 116 can include dampers or other flow control elements that can be operated to control an amount of the supply airflow provided to individual zones of building 10. In other embodiments, airside system 130 delivers the supply airflow into one or more zones of building 10 (e.g., via supply ducts 112) without using intermediate VAV units 116 or other flow control elements. AHU 106 can include various sensors (e.g., temperature sensors, pressure sensors, etc.) configured to measure attributes of the supply airflow. AHU 106 may receive input from sensors located within AHU 106 and/or within the building zone and may adjust the flow rate, temperature, or other attributes of the supply airflow through AHU 106 to achieve setpoint conditions for the building zone.

### Waterside System

Referring now to FIG. 2, a block diagram of a waterside system 200 is shown, according to some embodiments. In various embodiments, waterside system 200 may supplement or replace waterside system 120 in HVAC system 100 or can be implemented separate from HVAC system 100. When implemented in HVAC system 100, waterside system 200 can include a subset of the HVAC devices in HVAC system 100 (e.g., boiler 104, chiller 102, pumps, valves, etc.) and may operate to supply a heated or chilled fluid to AHU 106. The HVAC devices of waterside system 200 can be located within building 10 (e.g., as components of waterside system 120) or at an offsite location such as a central plant.

In FIG. 2, waterside system 200 is shown as a central plant having a plurality of subplants 202-212. Subplants 202-212 are shown to include a heater subplant 202, a heat recovery chiller subplant 204, a chiller subplant 206, a cooling tower subplant 208, a hot thermal energy storage (TES) subplant 210, and a cold thermal energy storage (TES) subplant 212. Subplants 202-212 consume resources (e.g., water, natural gas, electricity, etc.) from utilities to serve thermal energy loads (e.g., hot water, cold water, heating, cooling, etc.) of a building or campus. For example, heater subplant 202 can be configured to heat water in a hot water loop 214 that circulates the hot water between heater subplant 202 and building 10. Chiller subplant 206 can be configured to chill water in a cold water loop 216 that circulates the cold water between chiller subplant 206 building 10. Heat recovery chiller subplant 204 can be configured to transfer heat from cold water loop 216 to hot water loop 214 to provide additional heating for the hot water and additional cooling for the cold water. Condenser water loop 218 may absorb heat from the cold water in chiller subplant 206 and reject the absorbed heat in cooling tower subplant 208 or transfer the absorbed heat to hot water loop 214. Hot TES subplant 210 and cold TES subplant 212 may store hot and cold thermal energy, respectively, for subsequent use.

Hot water loop 214 and cold water loop 216 may deliver the heated and/or chilled water to air handlers located on the rooftop of building 10 (e.g., AHU 106) or to individual floors or zones of building 10 (e.g., VAV units 116). The air handlers push air past heat exchangers (e.g., heating coils or cooling coils) through which the water flows to provide heating or cooling for the air. The heated or cooled air can be delivered to individual zones of building 10 to serve thermal energy loads of building 10. The water then returns to subplants 202-212 to receive further heating or cooling.

Although subplants 202-212 are shown and described as heating and cooling water for circulation to a building, it is understood that any other type of working fluid (e.g., glycol, CO2, etc.) can be used in place of or in addition to water to serve thermal energy loads. In other embodiments, subplants 202-212 may provide heating and/or cooling directly to the building or campus without requiring an intermediate heat transfer fluid. These and other variations to waterside system 200 are within the teachings of the present disclosure.

Each of subplants 202-212 can include a variety of equipment configured to facilitate the functions of the subplant. For example, heater subplant 202 is shown to include a plurality of heating elements 220 (e.g., boilers, electric heaters, etc.) configured to add heat to the hot water in hot water loop 214. Heater subplant 202 is also shown to include several pumps 222 and 224 configured to circulate the hot water in hot water loop 214 and to control the flow rate of the hot water through individual heating elements 220. Chiller subplant 206 is shown to include a plurality of chillers 232 configured to remove heat from the cold water in cold water loop 216. Chiller subplant 206 is also shown to include several pumps 234 and 236 configured to circulate the cold water in cold water loop 216 and to control the flow rate of the cold water through individual chillers 232.

Heat recovery chiller subplant 204 is shown to include a plurality of heat recovery heat exchangers 226 (e.g., refrigeration circuits) configured to transfer heat from cold water loop 216 to hot water loop 214. Heat recovery chiller subplant 204 is also shown to include several pumps 228 and 230 configured to circulate the hot water and/or cold water through heat recovery heat exchangers 226 and to control the flow rate of the water through individual heat recovery heat exchangers 226. Cooling tower subplant 208 is shown to include a plurality of cooling towers 238 configured to remove heat from the condenser water in condenser water loop 218. Cooling tower subplant 208 is also shown to include several pumps 240 configured to circulate the condenser water in condenser water loop 218 and to control the flow rate of the condenser water through individual cooling towers 238.

Hot TES subplant 210 is shown to include a hot TES tank 242 configured to store the hot water for later use. Hot TES subplant 210 may also include one or more pumps or valves configured to control the flow rate of the hot water into or out of hot TES tank 242. Cold TES subplant 212 is shown to include cold TES tanks 244 configured to store the cold water for later use. Cold TES subplant 212 may also include one or more pumps or valves configured to control the flow rate of the cold water into or out of cold TES tanks 244.

In some embodiments, one or more of the pumps in waterside system 200 (e.g., pumps 222, 224, 228, 230, 234, 236, and/or 240) or pipelines in waterside system 200 include an isolation valve associated therewith. Isolation valves can be integrated with the pumps or positioned upstream or downstream of the pumps to control the fluid flows in waterside system 200. In various embodiments, waterside system 200 can include more, fewer, or different types of devices and/or subplants based on the particular configuration of waterside system 200 and the types of loads served by waterside system 200.

### Airside System

Referring now to FIG. 3, a block diagram of an airside system 300 is shown, according to some embodiments. In various embodiments, airside system 300 may supplement or replace airside system 130 in HVAC system 100 or can be implemented separate from HVAC system 100. When implemented in HVAC system 100, airside system 300 can include a subset of the HVAC devices in HVAC system 100 (e.g., AHU 106, VAV units 116, ducts 112-114, fans, dampers, etc.) and can be located in or around building 10. Airside system 300 may operate to heat or cool an airflow provided to building 10 using a heated or chilled fluid provided by waterside system 200.

In FIG. 3, airside system 300 is shown to include an economizer-type air handling unit (AHU) 302. Economizer-type AHUs vary the amount of outside air and return air used by the air handling unit for heating or cooling. For example, AHU 302 may receive return air 304 from building zone 306 via return air duct 308 and may deliver supply air 310 to building zone 306 via supply air duct 312. In some embodiments, AHU 302 is a rooftop unit located on the roof of building 10 (e.g., AHU 106 as shown in FIG. 1) or otherwise positioned to receive both return air 304 and outside air 314. AHU 302 can be configured to operate exhaust air damper 316, mixing damper 318, and outside air damper 320 to control an amount of outside air 314 and return air 304 that combine to form supply air 310. Any return air 304 that does not pass through mixing damper 318 can be exhausted from AHU 302 through exhaust damper 316 as exhaust air 322.

Each of dampers 316-320 can be operated by an actuator. For example, exhaust air damper 316 can be operated by actuator 324, mixing damper 318 can be operated by actuator 326, and outside air damper 320 can be operated by actuator 328. Actuators 324-328 may communicate with an AHU controller 330 via a communications link 332. Actuators 324-328 may receive control signals from AHU controller 330 and may provide feedback signals to AHU controller 330. Feedback signals can include, for example, an indication of a current actuator or damper position, an amount of torque or force exerted by the actuator, diagnostic information (e.g., results of diagnostic tests performed by actuators 324-328), status information, commissioning information, configuration settings, calibration data, and/or other types of information or data that can be collected, stored, or used by actuators 324-328. AHU controller 330 can be an economizer controller configured to use one or more control algorithms (e.g., state-based algorithms, extremum seeking control (ESC) algorithms, proportional-integral (PI) control algorithms, proportional-integral-derivative (PID) control algorithms, model predictive control (MPC) algorithms, feedback control algorithms, etc.) to control actuators 324-328.

Still referring to FIG. 3, AHU 302 is shown to include a cooling coil 334, a heating coil 336, and a fan 338 positioned within supply air duct 312. Fan 338 can be configured to force supply air 310 through cooling coil 334 and/or heating coil 336 and provide supply air 310 to building zone 306. AHU controller 330 may communicate with fan 338 via communications link 340 to control a flow rate of supply air 310. In some embodiments, AHU controller 330 controls an amount of heating or cooling applied to supply air 310 by modulating a speed of fan 338.

Cooling coil 334 may receive a chilled fluid from waterside system 200 (e.g., from cold water loop 216) via piping 342 and may return the chilled fluid to waterside system 200 via piping 344. Valve 346 can be positioned along piping 342 or piping 344 to control a flow rate of the chilled fluid through cooling coil 334. In some embodiments, cooling coil 334 includes multiple stages of cooling coils that can be independently activated and deactivated (e.g., by AHU controller 330, by BMS controller 366, etc.) to modulate an amount of cooling applied to supply air 310.

Heating coil 336 may receive a heated fluid from waterside system 200 (e.g., from hot water loop 214) via piping 348 and may return the heated fluid to waterside system 200 via piping 350. Valve 352 can be positioned along piping 348 or piping 350 to control a flow rate of the heated fluid through heating coil 336. In some embodiments, heating coil 336 includes multiple stages of heating coils that can be independently activated and deactivated (e.g., by AHU controller 330, by BMS controller 366, etc.) to modulate an amount of heating applied to supply air 310.

Each of valves 346 and 352 can be controlled by an actuator. For example, valve 346 can be controlled by actuator 354 and valve 352 can be controlled by actuator 356. Actuators 354-356 may communicate with AHU controller 330 via communications links 358-360. Actuators 354-356 may receive control signals from AHU controller 330 and may provide feedback signals to controller 330. In some embodiments, AHU controller 330 receives a measurement of the supply air temperature from a temperature sensor 362 positioned in supply air duct 312 (e.g., downstream of cooling coil 334 and/or heating coil 336). AHU controller 330 may also receive a measurement of the temperature of building zone 306 from a temperature sensor 364 located in building zone 306.

In some embodiments, AHU controller 330 operates valves 346 and 352 via actuators 354-356 to modulate an amount of heating or cooling provided to supply air 310 (e.g., to achieve a setpoint temperature for supply air 310 or to maintain the temperature of supply air 310 within a setpoint temperature range). The positions of valves 346 and 352 affect the amount of heating or cooling provided to supply air 310 by cooling coil 334 or heating coil 336 and may correlate with the amount of energy consumed to achieve a desired supply air temperature. AHU 330 may control the temperature of supply air 310 and/or building zone 306 by activating or deactivating coils 334-336, adjusting a speed of fan 338, or a combination of both.

Still referring to FIG. 3, airside system 300 is shown to include a building management system (BMS) controller 366 and a client device 368. BMS controller 366 can include one or more computer systems (e.g., servers, supervisory controllers, subsystem controllers, etc.) that serve as system level controllers, application or data servers, head nodes, or master controllers for airside system 300, waterside system 200, HVAC system 100, and/or other controllable systems that serve building 10. BMS controller 366 may communicate with multiple downstream building systems or subsystems (e.g., HVAC system 100, a security system, a lighting system, waterside system 200, etc.) via a communications link 370 according to like or disparate protocols (e.g., LON, BACnet, etc.). In various embodiments, AHU controller 330 and BMS controller 366 can be separate (as shown in FIG. 3) or integrated. In an integrated implementation, AHU controller 330 can be a software module configured for execution by a processor of BMS controller 366.

In some embodiments, AHU controller 330 receives information from BMS controller 366 (e.g., commands, setpoints, operating boundaries, etc.) and provides information to BMS controller 366 (e.g., temperature measurements, valve or actuator positions, operating statuses, diagnostics, etc.). For example, AHU controller 330 may provide BMS controller 366 with temperature measurements from temperature sensors 362-364, equipment on/off states, equipment operating capacities, and/or any other information that can be used by BMS controller 366 to monitor or control a variable state or condition within building zone 306.

Client device 368 can include one or more human-machine interfaces or client interfaces (e.g., graphical user interfaces, reporting interfaces, text-based computer interfaces, client-facing web services, web servers that provide pages to web clients, etc.) for controlling, viewing, or otherwise interacting with HVAC system 100, its subsystems, and/or devices. Client device 368 can be a computer workstation, a client terminal, a remote or local interface, or any other type of user interface device. Client device 368 can be a stationary terminal or a mobile device. For example, client device 368 can be a desktop computer, a computer server with a user interface, a laptop computer, a tablet, a smartphone, a PDA, or any other type of mobile or non-mobile device. Client device 368 may communicate with BMS controller 366 and/or AHU controller 330 via communications link 372.

### Building Management Systems

Referring now to FIG. 4, a block diagram of a building management system (BMS) 400 is shown, according to some embodiments. BMS 400 can be implemented in building 10 to automatically monitor and control various building functions. BMS 400 is shown to include BMS controller 366 and a plurality of building subsystems 428. Building subsystems 428 are shown to include a building electrical subsystem 434, an information communication technology (ICT) subsystem 436, a security subsystem 438, a HVAC subsystem 440, a lighting subsystem 442, a lift/escalators subsystem 432, and a fire safety subsystem 430. In various embodiments, building subsystems 428 can include fewer, additional, or alternative subsystems. For example, building subsystems 428 may also or alternatively include a refrigeration subsystem, an advertising or signage subsystem, a cooking subsystem, a vending subsystem, a printer or copy service subsystem, or any other type of building subsystem that uses controllable equipment and/or sensors to monitor or control building 10. In some embodiments, building subsystems 428 include HVAC system 100, waterside system 200 and/or airside system 300, as described with reference to FIGS. 1, 2 and 3.

Each of building subsystems 428 can include any number of devices, controllers, and connections for completing its individual functions and control activities. HVAC subsystem 440 can include many of the same components as HVAC system 100, as described with reference to FIGS. 1-3. For example, HVAC subsystem 440 can include a chiller, a boiler, any number of air handling units, economizers, field controllers, supervisory controllers, actuators, temperature sensors, and other devices for controlling the temperature, humidity, airflow, or other variable conditions within building 10. Lighting subsystem 442 can include any number of light fixtures, ballasts, lighting sensors, dimmers, or other devices configured to controllably adjust the amount of light provided to a building space. Security subsystem 438 can include occupancy sensors, video surveillance cameras, digital video recorders, video processing servers, intrusion detection devices, access control devices and servers, or other security-related devices.

Still referring to FIG. 4, BMS controller 366 is shown to include a communications interface 407 and a BMS interface 409. Interface 407 may facilitate communications between BMS controller 366 and external applications (e.g., monitoring and reporting applications 422, enterprise control applications 426, remote systems and applications 444, applications residing on client devices 448, etc.) for allowing user control, monitoring, and adjustment to BMS controller 366 and/or subsystems 428. Interface 407 may also facilitate communications between BMS controller 366 and client devices 448. BMS interface 409 may facilitate communications between BMS controller 366 and building subsystems 428 (e.g., HVAC, lighting security, lifts, power distribution, business, etc.).

Interfaces 407, 409 can be or include wired or wireless communications interfaces (e.g., jacks, antennas, transmitters, receivers, transceivers, wire terminals, etc.) for conducting data communications with building subsystems 428 or other external systems or devices. In various embodiments, communications via interfaces 407, 409 can be direct (e.g., local wired or wireless communications) or via a communications network 446 (e.g., a WAN, the Internet, a cellular network, etc.). For example, interfaces 407, 409 can include an Ethernet card and port for sending and receiving data via an Ethernet-based communications link or network. In another example, interfaces 407, 409 can include a Wi-Fi transceiver for communicating via a wireless communications network. In another example, one or both of interfaces 407, 409 can include cellular or mobile phone communications transceivers. In one embodiment, communications interface 407 is a power line communications interface and BMS interface 409 is an Ethernet interface. In other embodiments, both communications interface 407 and BMS interface 409 are Ethernet interfaces or are the same Ethernet interface.

Still referring to FIG. 4, BMS controller 366 is shown to include a processing circuit 404 including a processor 406 and memory 408. Processing circuit 404 can be communicably connected to BMS interface 409 and/or communications interface 407 such that processing circuit 404 and the various components thereof can send and receive data via interfaces 407, 409. Processor 406 can be implemented as a general purpose processor, an application specific integrated circuit (ASIC), one or more field programmable gate arrays (FPGAs), a group of processing components, or other suitable electronic processing components.

Memory 408 (e.g., memory, memory unit, storage device, etc.) can include one or more devices (e.g., RAM, ROM, Flash memory, hard disk storage, etc.) for storing data and/or computer code for completing or facilitating the various processes, layers and modules described in the present application. Memory 408 can be or include volatile memory or non-volatile memory. Memory 408 can include database components, object code components, script components, or any other type of information structure for supporting the various activities and information structures described in the present application. According to some embodiments, memory 408 is communicably connected to processor 406 via processing circuit 404 and includes computer code for executing (e.g., by processing circuit 404 and/or processor 406) one or more processes described herein.

In some embodiments, BMS controller 366 is implemented within a single computer (e.g., one server, one housing, etc.). In various other embodiments BMS controller 366 can be distributed across multiple servers or computers (e.g., that can exist in distributed locations). Further, while FIG. 4 shows applications 422 and 426 as existing outside of BMS controller 366, in some embodiments, applications 422 and 426 can be hosted within BMS controller 366 (e.g., within memory 408).

Still referring to FIG. 4, memory 408 is shown to include an enterprise integration layer 410, an automated measurement and validation (AM&V) layer 412, a demand response (DR) layer 414, a fault detection and diagnostics (FDD) layer 416, an integrated control layer 418, and a building subsystem integration later 420. Layers 410-420 can be configured to receive inputs from building subsystems 428 and other data sources, determine optimal control actions for building subsystems 428 based on the inputs, generate control signals based on the optimal control actions, and provide the generated control signals to building subsystems 428. The following paragraphs describe some of the general functions performed by each of layers 410-420 in BMS 400.

Enterprise integration layer 410 can be configured to serve clients or local applications with information and services to support a variety of enterprise-level applications. For example, enterprise control applications 426 can be configured to provide subsystem-spanning control to a graphical user interface (GUI) or to any number of enterprise-level business applications (e.g., accounting systems, user identification systems, etc.). Enterprise control applications 426 may also or alternatively be configured to provide configuration GUIs for configuring BMS controller 366. In yet other embodiments, enterprise control applications 426 can work with layers 410-420 to optimize building performance (e.g., efficiency, energy use, comfort, or safety) based on inputs received at interface 407 and/or BMS interface 409.

Building subsystem integration layer 420 can be configured to manage communications between BMS controller 366 and building subsystems 428. For example, building subsystem integration layer 420 may receive sensor data and input signals from building subsystems 428 and provide output data and control signals to building subsystems 428. Building subsystem integration layer 420 may also be configured to manage communications between building subsystems 428. Building subsystem integration layer 420 translate communications (e.g., sensor data, input signals, output signals, etc.) across a plurality of multi-vendor/multi-protocol systems.

Demand response layer 414 can be configured to optimize resource usage (e.g., electricity use, natural gas use, water use, etc.) and/or the monetary cost of such resource usage in response to satisfy the demand of building 10. The optimization can be based on time-of-use prices, curtailment signals, energy availability, or other data received from utility providers, distributed energy generation systems 424, from energy storage 427 (e.g., hot TES 242, cold TES 244, etc.), or from other sources. Demand response layer 414 may receive inputs from other layers of BMS controller 366 (e.g., building subsystem integration layer 420, integrated control layer 418, etc.). The inputs received from other layers can include environmental or sensor inputs such as temperature, carbon dioxide levels, relative humidity levels, air quality sensor outputs, occupancy sensor outputs, room schedules, and the like. The inputs may also include inputs such as electrical use (e.g., expressed in kWh), thermal load measurements, pricing information, projected pricing, smoothed pricing, curtailment signals from utilities, and the like.

According to some embodiments, demand response layer 414 includes control logic for responding to the data and signals it receives. These responses can include communicating with the control algorithms in integrated control layer 418, changing control strategies, changing setpoints, or activating/deactivating building equipment or subsystems in a controlled manner. Demand response layer 414 may also include control logic configured to determine when to utilize stored energy. For example, demand response layer 414 may determine to begin using energy from energy storage 427 just prior to the beginning of a peak use hour.

In some embodiments, demand response layer 414 includes a control module configured to actively initiate control actions (e.g., automatically changing setpoints) which minimize energy costs based on one or more inputs representative of or based on demand (e.g., price, a curtailment signal, a demand level, etc.). In some embodiments, demand response layer 414 uses equipment models to determine an optimal set of control actions. The equipment models can include, for example, thermodynamic models describing the inputs, outputs, and/or functions performed by various sets of building equipment. Equipment models may represent collections of building equipment (e.g., subplants, chiller arrays, etc.) or individual devices (e.g., individual chillers, heaters, pumps, etc.).

Demand response layer 414 may further include or draw upon one or more demand response policy definitions (e.g., databases, XML files, etc.). The policy definitions can be edited or adjusted by a user (e.g., via a graphical user interface) so that the control actions initiated in response to demand inputs can be tailored for the user's application, desired comfort level, particular building equipment, or based on other concerns. For example, the demand response policy definitions can specify which equipment can be turned on or off in response to particular demand inputs, how long a system or piece of equipment should be turned off, what setpoints can be changed, what the allowable set point adjustment range is, how long to hold a high demand setpoint before returning to a normally scheduled setpoint, how close to approach capacity limits, which equipment modes to utilize, the energy transfer rates (e.g., the maximum rate, an alarm rate, other rate boundary information, etc.) into and out of energy storage devices (e.g., thermal storage tanks, battery banks, etc.), and when to dispatch on-site generation of energy (e.g., via fuel cells, a motor generator set, etc.).

Integrated control layer 418 can be configured to use the data input or output of building subsystem integration layer 420 and/or demand response later 414 to make control decisions. Due to the subsystem integration provided by building subsystem integration layer 420, integrated control layer 418 can integrate control activities of the subsystems 428 such that the subsystems 428 behave as a single integrated supersystem. In some embodiments, integrated control layer 418 includes control logic that uses inputs and outputs from a plurality of building subsystems to provide greater comfort and energy savings relative to the comfort and energy savings that separate subsystems could provide alone. For example, integrated control layer 418 can be configured to use an input from a first subsystem to make an energy-saving control decision for a second subsystem. Results of these decisions can be communicated back to building subsystem integration layer 420.

Integrated control layer 418 is shown to be logically below demand response layer 414. Integrated control layer 418 can be configured to enhance the effectiveness of demand response layer 414 by enabling building subsystems 428 and their respective control loops to be controlled in coordination with demand response layer 414. This configuration may advantageously reduce disruptive demand response behavior relative to conventional systems. For example, integrated control layer 418 can be configured to assure that a demand response-driven upward adjustment to the setpoint for chilled water temperature (or another component that directly or indirectly affects temperature) does not result in an increase in fan energy (or other energy used to cool a space) that would result in greater total building energy use than was saved at the chiller.

Integrated control layer 418 can be configured to provide feedback to demand response layer 414 so that demand response layer 414 checks that constraints (e.g., temperature, lighting levels, etc.) are properly maintained even while demanded load shedding is in progress. The constraints may also include setpoint or sensed boundaries relating to safety, equipment operating limits and performance, comfort, fire codes, electrical codes, energy codes, and the like. Integrated control layer 418 is also logically below fault detection and diagnostics layer 416 and automated measurement and validation layer 412. Integrated control layer 418 can be configured to provide calculated inputs (e.g., aggregations) to these higher levels based on outputs from more than one building subsystem.

Automated measurement and validation (AM&V) layer 412 can be configured to verify that control strategies commanded by integrated control layer 418 or demand response layer 414 are working properly (e.g., using data aggregated by AM&V layer 412, integrated control layer 418, building subsystem integration layer 420, FDD layer 416, or otherwise). The calculations made by AM&V layer 412 can be based on building system energy models and/or equipment models for individual BMS devices or subsystems. For example, AM&V layer 412 may compare a model-predicted output with an actual output from building subsystems 428 to determine an accuracy of the model.

Fault detection and diagnostics (FDD) layer 416 can be configured to provide on-going fault detection for building subsystems 428, building subsystem devices (i.e., building equipment), and control algorithms used by demand response layer 414 and integrated control layer 418. FDD layer 416 may receive data inputs from integrated control layer 418, directly from one or more building subsystems or devices, or from another data source. FDD layer 416 may automatically diagnose and respond to detected faults. The responses to detected or diagnosed faults can include providing an alert message to a user, a maintenance scheduling system, or a control algorithm configured to attempt to repair the fault or to work-around the fault.

FDD layer 416 can be configured to output a specific identification of the faulty component or cause of the fault (e.g., loose damper linkage) using detailed subsystem inputs available at building subsystem integration layer 420. In other exemplary embodiments, FDD layer 416 is configured to provide “fault” events to integrated control layer 418 which executes control strategies and policies in response to the received fault events. According to some embodiments, FDD layer 416 (or a policy executed by an integrated control engine or business rules engine) may shut-down systems or direct control activities around faulty devices or systems to reduce energy waste, extend equipment life, or assure proper control response.

FDD layer 416 can be configured to store or access a variety of different system data stores (or data points for live data). FDD layer 416 may use some content of the data stores to identify faults at the equipment level (e.g., specific chiller, specific AHU, specific terminal unit, etc.) and other content to identify faults at component or subsystem levels. For example, building subsystems 428 may generate temporal (i.e., time-series) data indicating the performance of BMS 400 and the various components thereof. The data generated by building subsystems 428 can include measured or calculated values that exhibit statistical characteristics and provide information about how the corresponding system or process (e.g., a temperature control process, a flow control process, etc.) is performing in terms of error from its setpoint. These processes can be examined by FDD layer 416 to expose when the system begins to degrade in performance and alert a user to repair the fault before it becomes more severe.

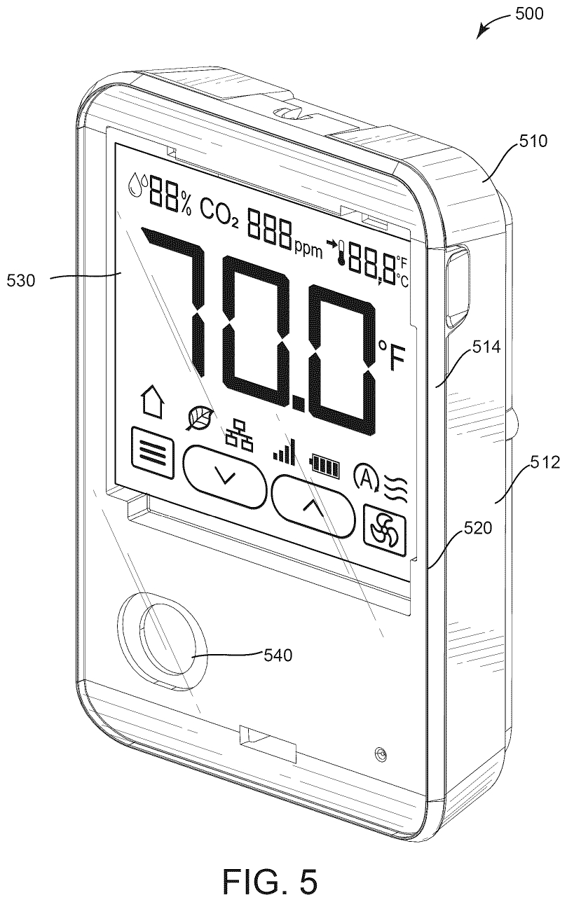

Referring now to FIG. 5, a drawing of an electronic device for controlling building equipment is shown as thermostat 500, according to an exemplary embodiment. While shown as a thermostat, thermostat 500 may also be an electronic device such as a control device, a sensor device or a user input terminal. Thermostat 500 can include many of the same components as BMS controller 366, as described with reference to FIGS. 1-4. The thermostat 500 is shown to include a housing 510 with a face plate 520, a user interface 530, and a sensor 540.

The face plate 520 may be one of a plurality of possible face plates for use with the thermostat 500. Face plate 520 can be configured to attach to the housing 510 through retention features such as via an adhesive or other adhering material, snaps or tabs, fasteners, etc. In some embodiments, face plate 520 is made of transparent acrylic plastic or another clear material and allows a view of components behind face plate 520 (e.g., user interface 530). In some embodiments, graphics and/or opaque materials are applied to the back surface of face plate 520 and are visible from the front surface of face plate 520. Face plate 520 may be ornamentally modified by arrangements of the graphics and/or opaque materials to provide a number of display appearances for the thermostat 500. By way of example, a brand logo may be applied to the back of face plate 520 and remain viewable through the front surface of face plate 520. A graphic applied to the back of face plate 520 reduces the risk that the graphic could be scratched or otherwise damaged. The graphics may be applied to different instances of face plate 520 to complement different instances of user interfaces 530 integrated with different instances of thermostat 500. For example, a first thermostat 500 configured with an occupancy override display may use a first face plate 520 with applied occupancy override graphics while a second thermostat 500 configured with a digital display may use a second face plate 520 with applied digital display graphics.

The user interface 530 may include an interactive display that can display information to a user and receive input from the user. The user interface 530 can be a touchscreen or other type of electronic display configured to present information to a user in a visual format (e.g., as text, graphics, etc.) and receive input from a user (e.g., via a touch-sensitive panel). For example, the user interface 530 may include a touch-sensitive panel layered on top of an electronic visual display. A user can provide inputs through simple or multi-touch gestures by touching the user interface 530 with one or more fingers and/or with a stylus or pen. The user interface 530 can use any of a variety of touch-sensing technologies to receive user inputs, such as capacitive sensing (e.g., surface capacitance, projected capacitance, mutual capacitance, self-capacitance, etc.), resistive sensing, surface acoustic wave, infrared grid, infrared acrylic projection, optical imaging, dispersive signal technology, acoustic pulse recognition, or other touch-sensitive technologies known in the art. Many of these technologies allow for multi-touch responsiveness of user interface 530 allowing registration of touch in two or even more locations at once. The display may use any of a variety of display technologies such as light emitting diode (LED), organic light-emitting diode (OLED), liquid-crystal display (LCD), organic light-emitting transistor (OLET), surface-conduction electron-emitter display (SED), field emission display (FED), digital light processing (DLP), liquid crystal on silicon (LCoC), or any other display technologies known in the art. In some embodiments, the display of the user interface 530 is configured to present visual media (e.g., text, graphics, etc.) without requiring a backlight.

The sensor 540 can be any number and/or type of sensors as described herein or known in the art for detecting an environmental condition of a space or a user. For example, sensor 540 may include one or more of an inertial switch, an accelerometer, a mechanical switch, a sound sensor, a piezoelectric switch, a Peltier junction, an ultrasonic switch, an infrared switch, or a photodiode, a near-field communications (NFC) sensor, a radio frequency identification (RFID) sensor, a Bluetooth sensor, a capacitive proximity sensor, a biometric sensor, or any other sensor configured to detect the presence of a person or device, an air quality sensor (e.g., smoke detection sensor, a VoC sensor, a CO2 concentration sensor, a humidity sensor, a CO sensor, allergen sensor, pollutant sensor, or any other sensor configured to detect a variable state or condition of the environment) a visible light camera, a motion detector camera, an infrared camera, an ultraviolet camera, an optical sensor, or any other type of camera, a light sensor, or a vibration sensor. In some embodiments, the sensor 540 is physically separate from the user interface 530. In some embodiments, the sensor 540 is physically coupled to the user interface 530. For example, the sensor 540 can be an accelerometer mechanically coupled to the user interface 530 and configured to sense movement of the user interface 530. The movement can indicate the presence and/or presence of a user with the user interface 530.

In some embodiments, the thermostat 500 is configured to control the operation of the user interface 530 based on one or more signals received from the sensor 540. For example, thermostat 500 may reduce its power consumption but setting the user interface 530 to the “off” state, such that all or part of the user interface 530 is not drawing power or is drawing a reduced amount of power. In some embodiments, the “off” state is the default state of the user interface 530. When one or more signals from the sensor 540 is received, the thermostat 500 can be configured to activate the user interface 530 and thereby transition the user interface 530 to an “on” state to receive one or more user inputs. The one or more signals received from the sensor 540 may indicate that a user is present and/or interacting with the thermostat 500. Once a user has finished interacting with the thermostat 500 and/or left the proximity of the thermostat 500, the thermostat 500 may be configured to deactivate the user interface 530 and transition the user interface 530 back to the “off”′ state based on a lack of one or more signals from the sensor 540. In some embodiments, the thermostat 500 may transition the user interface 530 back to the “off” state when the sensor 540 has not provided one or more signals for the duration of a waiting period. The waiting period may be a predetermined amount of time, may vary based on the time of day, duration of user interaction, type of user interaction, location of thermostat 500, schedule of thermostat 500, or any other factor.

### Residential HVAC System

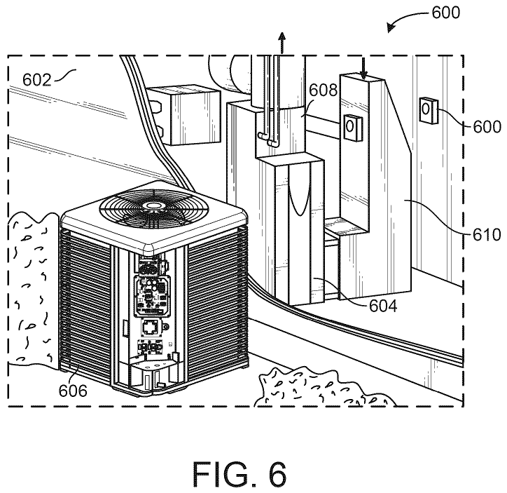

Referring now to FIG. 6, a residential heating and cooling system 600 is shown, according to an exemplary embodiment. The residential heating and cooling system 600 may provide heated and cooled air to a residential structure. Although described as a residential heating and cooling system 600, embodiments of the systems and methods described herein can be utilized in a cooling unit or a heating unit in a variety of applications include commercial HVAC units (e.g., roof top units). In general, a residence 602 includes refrigerant conduits that operatively couple an indoor unit 604 to an outdoor unit 606. Indoor unit 604 may be positioned in a utility space, an attic, a basement, and so forth. Outdoor unit 606 is situated adjacent to a side of residence 602. Refrigerant conduits transfer refrigerant between indoor unit 604 and outdoor unit 606, typically transferring primarily liquid refrigerant in one direction and primarily vaporized refrigerant in an opposite direction.

When the system 600 shown in FIG. 6 is operating as an air conditioner, a coil in outdoor unit 606 serves as a condenser for recondensing vaporized refrigerant flowing from indoor unit 604 to outdoor unit 606 via one of the refrigerant conduits. In these applications, a coil of the indoor unit 604, designated by the reference numeral 608, serves as an evaporator coil. Evaporator coil 608 receives liquid refrigerant (which may be expanded by an expansion device, not shown) and evaporates the refrigerant before returning it to outdoor unit 606.

Outdoor unit 606 draws in environmental air through its sides, forces the air through the outer unit coil using a fan, and expels the air. When operating as an air conditioner, the air is heated by the condenser coil within the outdoor unit 606 and exits the top of the unit at a temperature higher than it entered the sides. Air is blown over indoor coil 608 and is then circulated through residence 602 by means of ductwork 610, as indicated by the arrows entering and exiting ductwork 610. The overall system 600 operates to maintain a desired temperature as set by thermostat 500. When the temperature sensed inside the residence 602 is higher than the set point on the thermostat 500 (with the addition of a relatively small tolerance), the air conditioner will become operative to refrigerate additional air for circulation through the residence 602. When the temperature reaches the set point (with the removal of a relatively small tolerance), the unit can stop the refrigeration cycle temporarily.

In some embodiments, the system 600 configured so that the outdoor unit 606 is controlled to achieve a more elegant control over temperature and humidity within the residence 602. The outdoor unit 606 is controlled to operate components within the outdoor unit 606, and the system 600, based on a percentage of a delta between a minimum operating value of the compressor and a maximum operating value of the compressor plus the minimum operating value. In some embodiments, the minimum operating value and the maximum operating value are based on the determined outdoor ambient temperature, and the percentage of the delta is based on a predefined temperature differential multiplier and one or more time dependent multipliers.

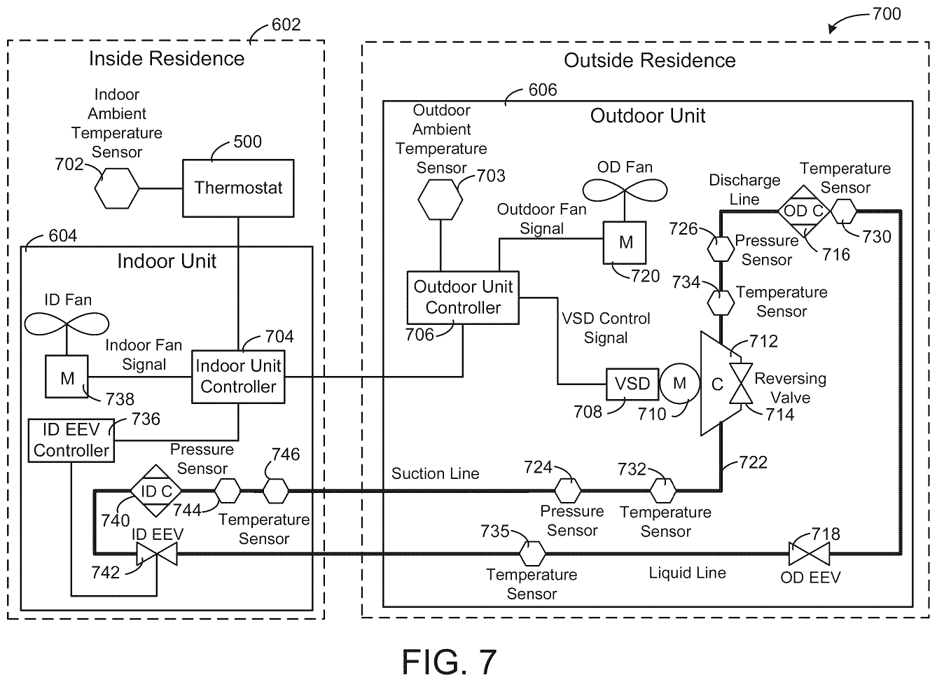

Referring now to FIG. 7, an HVAC system 700 is shown according to an exemplary embodiment. Various components of system 700 are located inside residence 602 while other components are located outside residence 602. Outdoor unit 606, as described with reference to FIG. 6, is shown to be located outside residence 602 while indoor unit 604 and thermostat 500, as described with reference to FIG. 6, are shown to be located inside the residence 602. In various embodiments, the thermostat 500 can cause the indoor unit 604 and the outdoor unit 606 to heat residence 602. In some embodiments, the thermostat 500 can cause the indoor unit 604 and the outdoor unit 606 to cool the residence 602. In other embodiments, the thermostat 500 can command an airflow change within the residence 602 to adjust the humidity within the residence 602.

Thermostat 500 can be configured to generate control signals for indoor unit 604 and/or outdoor unit 606. The thermostat 500 is shown to be connected to an indoor ambient temperature sensor 702, and an outdoor unit controller 706 is shown to be connected to an outdoor ambient temperature sensor 703. The indoor ambient temperature sensor 702 and the outdoor ambient temperature sensor 703 may be any kind of temperature sensor (e.g., thermistor, thermocouple, etc.). The thermostat 500 may measure the temperature of residence 602 via the indoor ambient temperature sensor 702. Further, the thermostat 500 can be configured to receive the temperature outside residence 602 via communication with the outdoor unit controller 706. In various embodiments, the thermostat 500 generates control signals for the indoor unit 604 and the outdoor unit 606 based on the indoor ambient temperature (e.g., measured via indoor ambient temperature sensor 702), the outdoor temperature (e.g., measured via the outdoor ambient temperature sensor 703), and/or a temperature set point.

The indoor unit 604 and the outdoor unit 606 may be electrically connected. Further, indoor unit 604 and outdoor unit 606 may be coupled via conduits 722. The outdoor unit 606 can be configured to compress refrigerant inside conduits 722 to either heat or cool the building based on the operating mode of the indoor unit 604 and the outdoor unit 606 (e.g., heat pump operation or air conditioning operation). The refrigerant inside conduits 722 may be any fluid that absorbs and extracts heat. For example, the refrigerant may be hydro fluorocarbon (HFC) based R-410A, R-407C, and/or R-134a.

The outdoor unit 606 is shown to include the outdoor unit controller 706, a variable speed drive 708, a motor 710 and a compressor 712. The outdoor unit 606 can be configured to control the compressor 712 and to further cause the compressor 712 to compress the refrigerant inside conduits 722. In this regard, the compressor 712 may be driven by the variable speed drive 708 and the motor 710. For example, the outdoor unit controller 706 can generate control signals for the variable speed drive 708. The variable speed drive 708 (e.g., an inverter, a variable frequency drive, etc.) may be an AC-AC inverter, a DC-AC inverter, and/or any other type of inverter. The variable speed drive 708 can be configured to vary the torque and/or speed of the motor 710 which in turn drives the speed and/or torque of compressor 712. The compressor 712 may be any suitable compressor such as a screw compressor, a reciprocating compressor, a rotary compressor, a swing link compressor, a scroll compressor, or a turbine compressor, etc.

In some embodiments, the outdoor unit controller 706 is configured to process data received from the thermostat 500 to determine operating values for components of the system 700, such as the compressor 712. In one embodiment, the outdoor unit controller 706 is configured to provide the determined operating values for the compressor 712 to the variable speed drive 708, which controls a speed of the compressor 712. The outdoor unit controller 706 is controlled to operate components within the outdoor unit 606, and the indoor unit 604, based on a percentage of a delta between a minimum operating value of the compressor and a maximum operating value of the compressor plus the minimum operating value. In some embodiments, the minimum operating value and the maximum operating value are based on the determined outdoor ambient temperature, and the percentage of the delta is based on a predefined temperature differential multiplier and one or more time dependent multipliers.

In some embodiments, the outdoor unit controller 706 can control a reversing valve 714 to operate system 700 as a heat pump or an air conditioner. For example, the outdoor unit controller 706 may cause reversing valve 714 to direct compressed refrigerant to the indoor coil 740 while in heat pump mode and to an outdoor coil 716 while in air conditioner mode. In this regard, the indoor coil 740 and the outdoor coil 716 can both act as condensers and evaporators depending on the operating mode (i.e., heat pump or air conditioner) of system 700.

Further, in various embodiments, outdoor unit controller 706 can be configured to control and/or receive data from an outdoor electronic expansion valve (EEV) 718. The outdoor electronic expansion valve 718 may be an expansion valve controlled by a stepper motor. In this regard, the outdoor unit controller 706 can be configured to generate a step signal (e.g., a PWM signal) for the outdoor electronic expansion valve 718. Based on the step signal, the outdoor electronic expansion valve 718 can be held fully open, fully closed, partial open, etc. In various embodiments, the outdoor unit controller 706 can be configured to generate a step signal for the outdoor electronic expansion valve 718 based on a subcool and/or superheat value calculated from various temperatures and pressures measured in system 700. In one embodiment, the outdoor unit controller 706 is configured to control the position of the outdoor electronic expansion valve 718 based on a percentage of a delta between a minimum operating value of the compressor and a maximum operating value of the compressor plus the minimum operating value. In some embodiments, the minimum operating value and the maximum operating value are based on the determined outdoor ambient temperature, and the percentage of the delta is based on a predefined temperature differential multiplier and one or more time dependent multipliers.

The outdoor unit controller 706 can be configured to control and/or power outdoor fan 720. The outdoor fan 720 can be configured to blow air over the outdoor coil 716. In this regard, the outdoor unit controller 706 can control the amount of air blowing over the outdoor coil 716 by generating control signals to control the speed and/or torque of outdoor fan 720. In some embodiments, the control signals are pulse wave modulated signals (PWM), analog voltage signals (i.e., varying the amplitude of a DC or AC signal), and/or any other type of signal. In one embodiment, the outdoor unit controller 706 can control an operating value of the outdoor fan 720, such as speed, based on a percentage of a delta between a minimum operating value of the compressor and a maximum operating value of the compressor plus the minimum operating value. In some embodiments, the minimum operating value and the maximum operating value are based on the determined outdoor ambient temperature, and the percentage of the delta is based on a predefined temperature differential multiplier and one or more time dependent multipliers.

The outdoor unit 606 may include one or more temperature sensors and one or more pressure sensors. The temperature sensors and pressure sensors may be electrical connected (i.e., via wires, via wireless communication, etc.) to the outdoor unit controller 706. In this regard, the outdoor unit controller 706 can be configured to measure and store the temperatures and pressures of the refrigerant at various locations of the conduits 722. The pressure sensors may be any kind of transducer that can be configured to sense the pressure of the refrigerant in the conduits 722. The outdoor unit 606 is shown to include pressure sensor 724. The pressure sensor 724 may measure the pressure of the refrigerant in conduit 722 in the suction line (i.e., a predefined distance from the inlet of compressor 712). Further, the outdoor unit 606 is shown to include pressure sensor 726. The pressure sensor 726 may be configured to measure the pressure of the refrigerant in conduits 722 on the discharge line (e.g., a predefined distance from the outlet of compressor 712).

The temperature sensors of outdoor unit 606 may include thermistors, thermocouples, and/or any other temperature sensing device. The outdoor unit 606 is shown to include temperature sensor 730, temperature sensor 732, temperature sensor 734, and temperature sensor 735. The temperature sensors (i.e., temperature sensor 730, temperature sensor 732, temperature sensor 735, and/or temperature sensor 746) can be configured to measure the temperature of the refrigerant at various locations inside conduits 722.

Referring now to the indoor unit 604, the indoor unit 604 is shown to include indoor unit controller 704, indoor electronic expansion valve controller 736, an indoor fan 738, an indoor coil 740, an indoor electronic expansion valve 742, a pressure sensor 744, and a temperature sensor 746. The indoor unit controller 704 can be configured to generate control signals for indoor electronic expansion valve controller 736. The signals may be set points (e.g., temperature set point, pressure set point, superheat set point, subcool set point, step value set point, etc.). In this regard, indoor electronic expansion valve controller 736 can be configured to generate control signals for indoor electronic expansion valve 742. In various embodiments, indoor electronic expansion valve 742 may be the same type of valve as outdoor electronic expansion valve 718. In this regard, indoor electronic expansion valve controller 736 can be configured to generate a step control signal (e.g., a PWM wave) for controlling the stepper motor of the indoor electronic expansion valve 742. In this regard, indoor electronic expansion valve controller 736 can be configured to fully open, fully close, or partially close the indoor electronic expansion valve 742 based on the step signal.

Indoor unit controller 704 can be configured to control indoor fan 738. The indoor fan 738 can be configured to blow air over indoor coil 740. In this regard, the indoor unit controller 704 can control the amount of air blowing over the indoor coil 740 by generating control signals to control the speed and/or torque of the indoor fan 738. In some embodiments, the control signals are pulse wave modulated signals (PWM), analog voltage signals (i.e., varying the amplitude of a DC or AC signal), and/or any other type of signal. In one embodiment, the indoor unit controller 704 may receive a signal from the outdoor unit controller indicating one or more operating values, such as speed for the indoor fan 738. In one embodiment, the operating value associated with the indoor fan 738 is an airflow, such as cubic feet per minute (CFM). In one embodiment, the outdoor unit controller 706 may determine the operating value of the indoor fan based on a percentage of a delta between a minimum operating value of the compressor and a maximum operating value of the compressor plus the minimum operating value. In some embodiments, the minimum operating value and the maximum operating value are based on the determined outdoor ambient temperature, and the percentage of the delta is based on a predefined temperature differential multiplier and one or more time dependent multipliers.

The indoor unit controller 704 may be electrically connected (e.g., wired connection, wireless connection, etc.) to pressure sensor 744 and/or temperature sensor 746. In this regard, the indoor unit controller 704 can take pressure and/or temperature sensing measurements via pressure sensor 744 and/or temperature sensor 746. In one embodiment, pressure sensor 744 and temperature sensor 746 are located on the suction line (i.e., a predefined distance from indoor coil 740). In other embodiments, the pressure sensor 744 and/or the temperature sensor 746 may be located on the liquid line (i.e., a predefined distance from indoor coil 740).

### Systems and Methods for Low-Power User Interface for Electronic Device

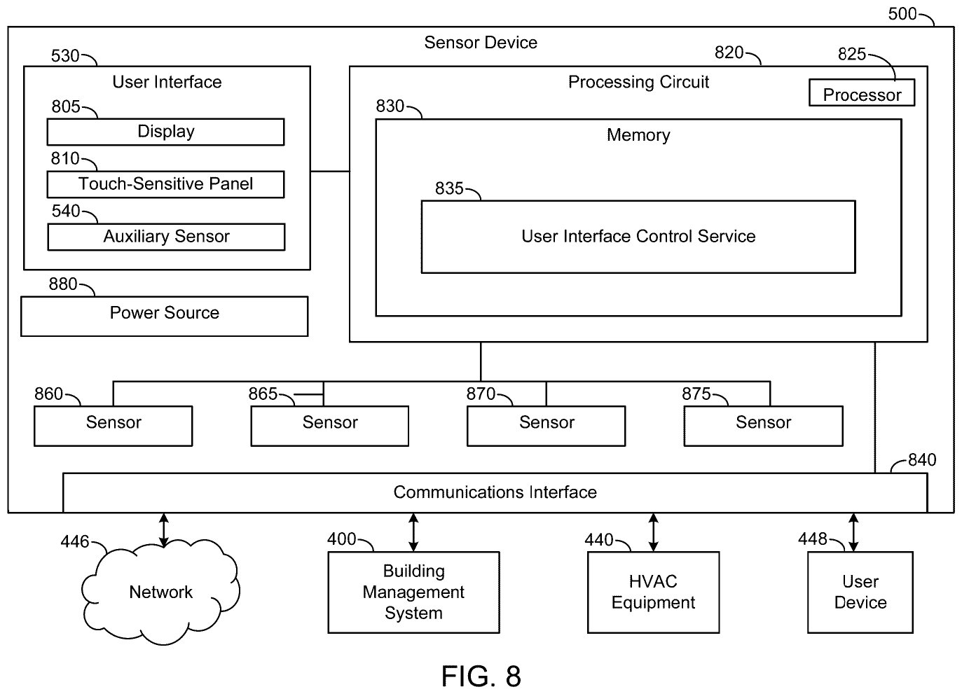

Turning now to FIG. 8, a block diagram of the thermostat 500 of FIG. 5 is shown, according to an exemplary embodiment. Thermostat 500 may generate control signals for a HVAC system (e.g., HVAC system 100) or BMS (e.g., BMS 400), may measure one or more environmental conditions of a space, may simultaneously display many unique environmental parameters, and may allow adjustment of multiple parameters from the user interface 530. Thermostat 500 may include a processing circuit 820, a user interface 530, a communications interface 840, auxiliary sensor 540, and a plurality of sensors 860, 865, 870, and 875. In some embodiments, thermostat 500 may be the same or similar to BMS controller 366.

User interface 530 may include a display 805 which may simultaneously display many unique environmental parameters and allow a user to interact with thermostat 500 as described in detail above. User interface 530 include a display 805 configured to present information to a user in a visual format (e.g., as text, graphics, etc.) and a touch-sensitive panel 810 can be a touchscreen or other type of electronic display configured to receive input from a user. For example, user interface 530 may include a touch-sensitive panel 810 layered on top of an electronic visual display 805. A user can provide inputs through simple or multi-touch gestures by touching the touch-sensitive panel 810 with one or more fingers and/or with a stylus or pen. Touch-sensitive panel 810 can use any of a variety of touch-sensing technologies to receive user inputs, such as capacitive sensing (e.g., surface capacitance, projected capacitance, mutual capacitance, self-capacitance, etc.), resistive sensing, surface acoustic wave, infrared grid, infrared acrylic projection, optical imaging, dispersive signal technology, acoustic pulse recognition, or other touch-sensitive technologies known in the art. Many of these technologies allow for multi-touch responsiveness of touch-sensitive panel 810 allowing registration of touch in two or even more locations at once.

The display 805 may use any of a variety of display technologies such as light emitting diode (LED), organic light-emitting diode (OLED), liquid-crystal display (LCD), organic light-emitting transistor (OLET), surface-conduction electron-emitter display (SED), field emission display (FED), digital light processing (DLP), liquid crystal on silicon (LCoC), or any other display technologies known in the art. In some embodiments, the display 805 is a fixed segment display configured to present visual media (e.g., text, graphics, etc.). In some embodiments, the display 805 is configured to present visual media without requiring a backlight.

User interface 530 may include an auxiliary sensor 540. The auxiliary sensor 540 may be the same or similar to sensor 540 described above. The auxiliary sensor 540 may be configured to detect the presence of a user and/or the interaction of the user with the user interface 530. For example, the auxiliary sensor 540 may include one or more of an inertial switch, an accelerometer, a mechanical switch, a sound sensor, a piezoelectric switch, a Peltier junction, an ultrasonic switch, an infrared switch, or a photodiode, a near-field communications (NFC) sensor, a radio frequency identification (RFID) sensor, a Bluetooth sensor, a capacitive proximity sensor, a biometric sensor, or any other sensor configured to detect the presence of a person or device.

In some embodiments, the auxiliary sensor 540 may be coupled to the display 805 and/or the touch-sensitive panel 810. In some embodiments, the auxiliary sensor 540 is mechanically coupled to the display 805 and/or the touch-sensitive panel 810 such that movement of the display 805 and/or the touch-sensitive panel 810 results in movement of the auxiliary sensor 540. For example, a user tapping on the display 805 and/or the touch-sensitive panel 810 can result in a small amount of movement that can be transferred to the auxiliary sensor 540. The auxiliary sensor 540 may be configured to detect the movement of the display 805 and/or the touch-sensitive panel 810. For example, the auxiliary sensor 540 may be an inertial switch, vibration sensor, or accelerometer configured to detect the movement. For another example, the auxiliary sensor 540 may be a mechanical switch configured to pass its actuation point based on the movement of the display 805 and/or the touch-sensitive panel 810. For another example, the auxiliary sensor 540 may be a piezoelectric switch which undergoes stress from movement of the display 805 and/or the touch-sensitive panel 810 due to the user interaction and which triggers the piezoelectric switch to generate a signal indicating the user interaction with the user interface 530.

In some embodiments, the auxiliary sensor 540 is electrically coupled to the display 805 and/or the touch-sensitive panel 810. For example, the auxiliary sensor 540 may be a sound sensor such as a microphone configured to detect the sound of an initial user interaction with the display 805 and/or the touch-sensitive panel 810 of the user interface 530. For another example, the auxiliary sensor 540 may be an ultrasonic sensor, infrared sensor, or other type of proximity sensor configured to detect a presence of the user in a proximity of the thermostat 500. For another example, the auxiliary sensor 540 may be a photodiode configured to detect changes in received light energy to detect a presence of a user in a proximity of the thermostat 500.

In some embodiments, the auxiliary sensor 540 may be thermally coupled to the display 805 and/or the touch-sensitive panel 810 of the user interface 530. For example, the auxiliary switch may be a Peltier junction thermally coupled to the display 805 and/or the touch-sensitive panel 810 and configured to detect a voltage change based on the thermal energy of user in contact with the display 805 and/or the touch-sensitive panel 810. It should be understood that the auxiliary sensor 540 may be any type of switch or sensor capable of detecting a user interacting with or in the proximity of the thermostat 500.

While shown as a part of user interface 530, in some embodiments the auxiliary sensor 540 is external to the user interface 530 but may otherwise be the same as auxiliary sensor 540. For example, at least one of the sensors 860, 865, 870, 875 may operate as the auxiliary sensor 540. In some embodiments, sensors 860, 865, 870, 875 may otherwise or alternatively be configured to measure a variable state or condition of the environment in which thermostat 500 is installed, and there can be any number and/or type of as described herein or known in the art. For example, sensors 860, 865, 870, 875 may include an occupancy sensor (e.g., a near-field communications (NFC) sensor, a radio frequency identification (RFID) sensor, a Bluetooth sensor, a capacitive proximity sensor, a biometric sensor, or any other sensor configured to detect the presence of a person or device), an air quality sensor (e.g., smoke detection sensor, a VoC sensor, a CO2 concentration sensor, a humidity sensor, a CO sensor, allergen sensor, pollutant sensor, etc.) a visible light camera, a motion detector camera, an infrared camera, an ultraviolet camera, an optical sensor, or any other type of camera, a microphone, a light sensor, or a vibration sensor.

Power source 880 may be any type of power source configured to provide power to the thermostat 500. In some embodiments, the power source 880 is a wired power source coupled to a building power system. In some embodiments, the power source 880 is a self-contained and/or wireless power source such as a battery or super capacitor.

Processing circuit 820 may be configured to receive input from the auxiliary sensor 540, the auxiliary sensor 540, and the sensors 860, 865, 870, generate control signals, and control user interface 530. Processing circuit 820 can include memory 830, processor 825, and communications interface 840. Processing circuit 820 can be communicably connected a HVAC system (e.g., HVAC system 100) or BMS system (e.g., BMS controller 366) via Communication interface 840 such that Processing circuit 820 and the various components thereof can send and receive data. Processor 825 can be implemented as a general purpose processor, an application specific integrated circuit (ASIC), one or more field programmable gate arrays (FPGAs), a group of processing components, or other suitable electronic processing

Communication interface 840 can communicatively couple thermostat 500 with other devices (e.g., servers, systems, etc.) and allow for the exchange of information between thermostat 500 and other devices or systems. In some embodiments, communication interface 840 communicatively couples the devices, systems, and servers of thermostat 500. In some embodiments, communication interface 840 is at least one of and/or a combination of a Wi-Fi network, a wired Ethernet network, a Zigbee network, a Bluetooth network, and/or any other wireless network. Communication interface 840 may be a local area network and/or a wide area network (e.g., the Internet, a building WAN, etc.) and may use a variety of communications protocols (e.g., BACnet, IP, LON, etc.). Communication interface 840 may include routers, modems, and/or network switches. Communication interface 840 may be a combination of wired and wireless networks.

Communications interface 840 may include a network interface configured to facilitate electronic data communications between thermostat 500 and various external systems or devices (e.g., network 446, building management system 400, building subsystems 428, user device 448, etc.) For example, thermostat 500 may receive information from building management system 400 or building subsystems 428 indicating one or more measured states of the controlled building (e.g., temperature, humidity, electric loads, etc.) and one or more states of the Building subsystems 428 (e.g., equipment status, power consumption, equipment availability, etc.). In some embodiments, building subsystems 428 may be lighting systems, building systems, actuators, chillers, heaters, and/or any other building equipment and/or system. The communication interface 840 between building subsystems 428 may be a three wire (power, ground a communication) or four wire (power, communication 1, communication 2, and ground, B, G, Y, R or W or O/B, C, K, R) connection. Communications interface 840 may receive inputs from building management system 400 or building subsystems 428 and may provide operating parameters (e.g., on/off decisions, set points, etc.) to building management system 400 or building subsystems 428. The operating parameters may cause building management system 400 to activate, deactivate, or adjust a set point for various types of home equipment or building equipment in communication with thermostat 500.

Memory 830 may include one or more devices (e.g., memory units, memory devices, storage devices, etc.) for storing data and/or computer code for completing and/or facilitating the various processes described in the present disclosure. Memory 830 may include random access memory (RAM), read-only memory (ROM), hard drive storage, temporary storage, non-volatile memory, flash memory, optical memory, or any other suitable memory for storing software objects and/or computer instructions. Memory 830 may include database components, object code components, script components, or any other type of information structure for supporting the various activities and information structures described in the present disclosure.

Memory 830 may be communicably connected to processor 825 via processing circuit 820 and may include computer code for executing (e.g., by processor 825) one or more processes described herein. For example, memory 830 includes user interface control service 835. The user interface control service 835 may activate and deactivate one or more parts of the user interface 530 to reduce a power consumption of the user interface. For example, the display 805 and/or the touch panel 810 may normally consume energy in the “on” state, even when not in use. To reduce the power consumption of the user interface 530, the user interface control service 835 can control the display 805 and/or the touch-sensitive panel 810 to be deactivated or “off”′ (e.g., an unpowered condition) in the “default” state when a user is not interacting with or near the thermostat 500. In some embodiments, the “off” state or deactivated state is simply a reduced power state. In some embodiments, in the reduced power state the user interface consumes no more than a de minimus amount of power, for example less than or equal to at least one of 50%, 40%, 30%, 20% or 10% of the power used in the activated state For example, in the “off”′ state a sample rate of the touch-sensitive panel 810 may be reduced, but the panel may still draw some power, but a reduced amount of power compared to the “on” or activated state. In some embodiments, the “off” state corresponds to the touch-sensitive panel 810 being “off” while the display 805 is “on.” Still in other embodiments, the “off” state corresponds to the touch-sensitive panel 810 being “off” and the display 805 being “off.” The user interface control service 835 can be configured to receive signals from one or more of the auxiliary sensor 540 and/or the sensors 860, 865, 870, 875 indicating a user is interacting with or near the thermostat 500. In response to the one or more signals, the user interface control service 835 can control the display 805 and/or the touch-sensitive panel 810 to the “on” state or active state (e.g., powered state) such that the display 805 and/or the touch-sensitive panel 810 can display information and/or receive a user input via the touch-sensitive panel 810.

In some embodiments, the signal received from the auxiliary sensor 540 and/or the sensors 860, 865, 870, 875 must exceed a threshold before the user interface controls service 835 transitions the control the display 805 and/or the touch-sensitive panel 810 from the “off” state to the “on” state. The threshold may be a frequency, a duration, a voltage threshold, etc. For example, when the auxiliary sensor 540 is a proximity sensor, the threshold may that the proximity sensor triggers twice within 2 seconds. For another example, when the auxiliary sensor 540 is a pressure or contact based sensor such as a inertial switch or an accelerometer, the threshold may be the auxiliary sensor 540 is triggered for a duration between 0 and 1 seconds. For example, the duration may be 0.05 seconds. For another example, the duration may be 0.1 seconds. In some embodiments, when the auxiliary sensor 540 is a piezoelectric switch or Peltier junction, the threshold may be a magnitude of the voltage generated by the auxiliary sensor 540. The threshold ensures that incidental or transitory contact or proximity of a user with the thermostat 500 is not sufficient to trigger the user interface control service 835 to transition the display 805 and/or the touch-sensitive panel 810 from the unpowered state to the powered state. The threshold may depend on the type of sensor, and there may be multiple thresholds, one for each type of sensor in the thermostat 500.

In some embodiments, the user interface control service 835 must receive signals from two or more of the auxiliary sensor 540 and/or the sensors 860, 865, 870, 875 before transitioning the display 805 and/or the touch-sensitive panel 810 from the “off” state to the “on” state. For example, the auxiliary sensor 540 may be an accelerometer coupled to the touch-interface panel 810 and one of the sensors 860, 865, 870, 875 may be a photodiode configured to detect a change in ambient light. When one of the auxiliary sensor 540 or the sensors 860, 865, 870, 875 triggers but not the other, the user interface control service 835 may maintain the display 805 and/or the touch-sensitive panel 810 in the “off” state. When both of the auxiliary sensor 540 or the sensors 860, 865, 870, 875 trigger, the user interface control service 835 may then transition the display 805 and/or the touch-sensitive panel 810 to the “on” state. The number of sensors that must agree may be two, or three, or four, or any other number. In some embodiments, as long as one of the auxiliary sensor 540 and/or the sensors 860, 865, 870, 875 triggers, the user interface control service 835 may then transition the display 805 and/or the touch-sensitive panel 810 to the “on” state, even though one or more of the other auxiliary sensor 540 and/or the sensors 860, 865, 870, 875 did not trigger.

In some embodiments, when one or more of the display 805 and/or the touch-sensitive panel 810 are in the “on” state, the user interface control service 835 keeps a running clock or timer. In some embodiments, the timer is initiated in response to the initial signals from the auxiliary sensor 540 and/or the sensors 860, 865, 870, 875 indicating a user is interacting with or near the thermostat 500. In some embodiments, the timer is initiated in response to the display 805 and/or the touch-sensitive panel 810 transitioning from the “off” state to the “on” state. In some embodiments, the timer is initiated when a user input is received via the user interface 530. In some embodiments, each successive user input may reset the timer.

In some embodiments, in response to the running clock or timer exceeding a predetermined time period such as a wait period, the user interface control surface is configured to deactivate or turn “off” one or more of the display 805 and/or the touch-sensitive panel 810. For example, after receiving a user input with the touch-sensitive panel 810 the timer maybe reset. After the timer meets or exceeds the wait period, indicating a lack of user interaction or proximity with the thermostat 500, the user interface control service 835 can deactivate the display 805 and/or the touch-sensitive panel 810 to reduce the power consumption of the user interface 530 when not in use. The user interface control service 835 can then monitor one or more of the auxiliary sensor 540 and/or the sensors 860, 865, 870, 875 to determine when to reactivate the display 805 and/or the touch-sensitive panel 810.

The duration of the predetermined time period may be static or variable. In some embodiments, the duration is set by a user of the thermostat 500. In some embodiments, the duration depends on one or more of the variables such as a schedule of the thermostat 500, the time of day, type of user interaction, location of thermostat 500, or any other factor. For example, the duration can be between 0 and 120 seconds. In some embodiments, the duration can be between 0 and 60 seconds. In some embodiments, the duration can be between 0 and 30 seconds. In some embodiments, the duration can be between 0 and 10 seconds. For example, the duration of the wait period can be 5 seconds.

In some embodiments, the threshold (e.g., duration, frequency, magnitude, etc.) required for resetting or restarting the timer is less than the threshold for activating the display 805 and/or the touch-sensitive panel 810. For example, in some embodiments in order to transition the display 805 and/or the touch-sensitive panel 810 from an “off”′ state to an “on” state the auxiliary sensor 540 must trigger at least two times within a second. However, in order to reset the timer, the auxiliary sensor 540 may only need to trigger at least one time within a second. Beneficially, the reduced threshold for resetting the timer increases the chances that the user interface 530 is active when a user desires to interact with the thermostat 500.

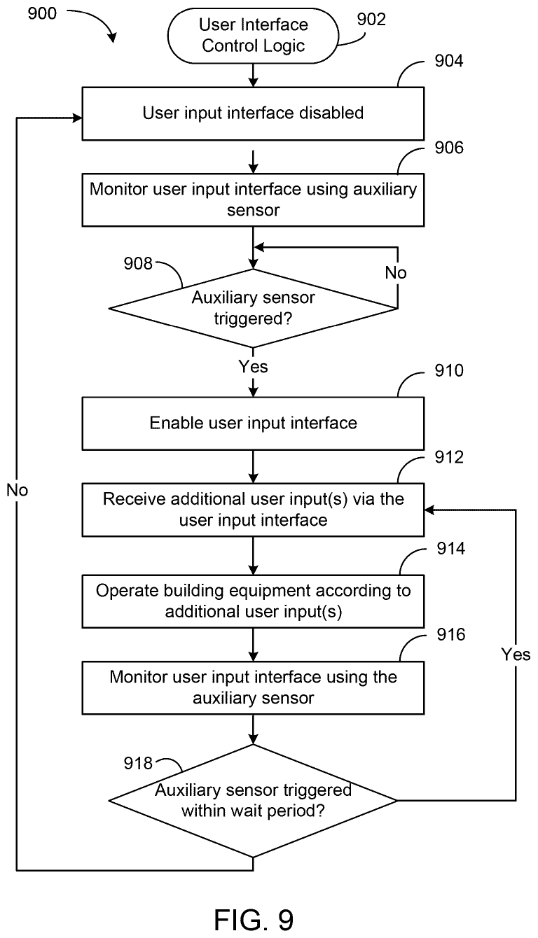

Referring now to FIG. 9, a flow diagram for a process 900 of controlling the power consumption of the user interface 530 of thermostat 500 is shown, according to an exemplary embodiment. Process 900 may be performed by user interface control service 835. The process 900 may start at step 902.

At step 904, the user input interface is disabled. In some embodiments, the user input interface corresponds with one or more parts of the user interface 530. For example, the touch-sensitive panel 810 may be disabled. The disabled state corresponds with an unpowered or reduced power state. Beneficially, in the disabled state the user interface 530 consumes less power, which may allow a thermostat 500 with a power source 880 of a battery last longer.

At step 906, the user input interface is monitoring using an auxiliary sensor. In some embodiments, the user input interface such as user interface 530 is also monitored by one or more other sensors, such as sensors 860, 865, 870, 875. The auxiliary sensor 540 or sensors 860, 865, 870, 875 may be coupled (e.g., mechanically, electrically, thermally, etc.) to the user interface 530.

At step 908, the thermostat 500 may determine if the auxiliary sensor is triggered. In some embodiments, the auxiliary sensor 540 is triggered when a signal is provided to the thermostat 500. In some embodiments, the auxiliary sensor 540 is triggered when the signal exceeds a predetermined threshold (e.g., duration, frequency, magnitude, etc.) In some embodiments, two or more of the auxiliary sensor 540 or sensors 860, 865, 870, 875 must trigger to satisfy step 908. If the auxiliary sensor 540 is not triggered, the user interface 530 remains in the “off” state and the process 900 returns to step 908. If the auxiliary sensor 540 is triggered, the process 900 may proceed to step 910.

At step 910, the thermostat 500 enables the user input interface. In some embodiments, the user interface control service 835 activates the display 805 and/or the touch-sensitive panel 810. At step 912, the thermostat 500 receives additional user inputs via the user input interface. In the active or “on” state, the user interface 530 is configured to receive one or more user inputs from the user to control or modify one or more parameters of the HVAC system (e.g., HVAC system 100) or BMS (e.g., BMS 400). The additional user inputs are in addition to the initial or first user inputs which trigger the auxiliary sensor 540 in step 908.

At step 914, the thermostat 500 operates building equipment according to the additional user inputs. In some embodiments, the thermostat 500 generates control signals to operate building equipment, such as, for example, indoor unit 604 or outdoor unit 606 of HVAC system 700. As described above, the thermostat 500 may allow adjustment of multiple parameters of the environmental state or condition of a building via the user interface 530.

At step 916, the thermostat 500 continues to monitor the user input interface using the auxiliary sensor. In some embodiments, the thermostat 500 also monitors the user interface 530 with one or more of the sensors 860, 865, 870, 875. The thermostat 500 continues to monitor the user interface 530 to determine if a user is still interacting or near the thermostat 500. In some embodiments, a wait period is initiated or run which the thermostat 500 monitors the user interface 530 within. For example, the wait period may begin at step 908 when the auxiliary sensor is triggered, at step 910, when the user input interface is enabled, and/or at step 912 when additional user inputs are received. In some embodiments, the wait period resets each time a user input is received vie the user interface 530. The wait period may be static or variable, and may be predetermined or selected by a user of the thermostat 500, as described herein.

At step 918, the thermostat 500 checks if the auxiliary sensor is triggered within the wait period. If the auxiliary sensor 540 is triggered within the wait period, then process 900 proceeds back to step 912 and receives the user input via the user interface 530. In some embodiments, the process 900 also resets the wait period (e.g., timer, running clock, etc.). If the auxiliary sensor 540 is not triggered within the wait period, then process 900 returns to step 904 and the user input interface is disabled. In this manner, after a period of inactivity, marked by the wait period elapsing without a trigger of the auxiliary sensor 540, the user interface 530 or a part of it (e.g., display 805, touch-sensitive panel 810) is disabled to reduce the power consumption of the thermostat 500. In some embodiments, at step 918 the threshold to trigger the auxiliary sensor 540 is reduced compared to the threshold required to trigger the auxiliary sensor 540 at step 908.

### Configuration of Exemplary Embodiments

The construction and arrangement of the systems and methods as shown in the various exemplary embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements may be reversed or otherwise varied and the nature or number of discrete elements or positions may be altered or varied. Accordingly, all such modifications are intended to be included within the scope of the present disclosure. The order or sequence of any process or method steps may be varied or re-sequenced according to alternative embodiments. Other substitutions, modifications, changes, and omissions may be made in the design, operating conditions and arrangement of the exemplary embodiments without departing from the scope of the present disclosure.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions include, for example, instructions and data which cause a general purpose computer, special purpose computer, or special purpose processing machines to perform a certain function or group of functions.

Although the figures show a specific order of method steps, the order of the steps may differ from what is depicted. Two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps and decision steps.

What is claimed is:

1. A sensor device for use in a building zone, comprising:
a plurality of sensor components, each sensor component configured to sense an environmental condition in the building zone;
a display configured to display one or more parameters representing the environmental condition in the building zone;
a user interface configured to receive a user input;
an auxiliary sensor coupled to the user interface and configured to detect movement of the user interface; and
a control circuit communicably coupled to the plurality of sensor components, the display, the user interface, and the auxiliary sensor, wherein in response to a first user detection signal from the auxiliary sensor indicating movement of the user interface, the control circuit is structured to activate the user interface to receive a first user input.

2. The sensor device of claim 1, wherein the user interface is a touch-based user interface.

3. The sensor device of claim 2, wherein the touch-based user interface is capacitive.

4. The sensor device of claim 1, wherein the auxiliary sensor is at least one of a mechanical switch, an inertial switch, an accelerometer, a piezoelectric switch, a sound sensor, an ultrasonic sensor.

5. The sensor device of claim 4, wherein the auxiliary sensor is configured to detect movement of the user interface indicating a user's presence.

6. The sensor device of claim 5, wherein the auxiliary sensor is mechanically coupled to the user interface.

7. The sensor device of claim 1, wherein the control circuit is further configured to determine if a second user detection signal from the auxiliary sensor is received within a waiting period initiated after the first user detection signal is received, and in response to determining that the second user detection signal is not received within the waiting period, deactivating the user interface.

8. The sensor device of claim 1, wherein the control circuit is further configured to deactivate the user interface after an predetermined elapsed time period without a user detection signal from the auxiliary sensor.

9. The sensor device of claim 1, wherein the display in an activated state consumes power than the display in a deactivated state and the display in the deactivated state does not consume more than a de minis amount of power.

10. A building management system (BMS), comprising:
building equipment operable to affect a state or condition of a building; and
a user input device comprising:
a display configured to display one or more parameters representing the state or condition of the building;
a user interface configured to receive a user input;
an auxiliary sensor coupled to the user interface and configured to detect movement of the user interface; and
a control circuit communicably coupled to the display, the user interface, and the auxiliary sensor, wherein in response to a first user detection signal from the auxiliary sensor indicating movement of the user interface, the control circuit is structured to activate the user interface to receive a first user input,
wherein the control circuit is further configured to operate the building equipment according to the first user input.

11. The BMS of claim 10, wherein the user interface is a touch-based user interface.

12. The BMS of claim 11, wherein the touch-based user interface is capacitive.

13. The BMS of claim 10, wherein the auxiliary sensor is at least one of a mechanical switch, an inertial switch, an accelerometer, a piezoelectric switch, a sound sensor, an ultrasonic sensor.

14. The BMS of claim 10, wherein the auxiliary sensor is mechanically coupled to the user interface.

15. The BMS of claim 10, wherein the control circuit is further configured to determine if a second user detection signal from the auxiliary sensor is received within a waiting period initiated after the first detection signal is received, and in response to determining that the second user detection signal is not received within the waiting period, deactivating the user interface.

16. The BMS of claim 10, wherein the control circuit is further configured to deactivate the user interface after an predetermined elapsed time period without a user detection signal from the auxiliary sensor.

17. A method of operating a sensor device, comprising the steps of:
providing a sensor device comprising a user interface configured to receive a user input and an auxiliary sensor configured to detect a movement of the user interface;
disabling the user interface;
detecting, via the auxiliary sensor, a first user input based on movement from the user interface;
enabling the user interface in response to the first user input;
receiving, via the user interface, a second user input; and
disabling the user interface, in response to not receiving a third user input from the auxiliary sensor within a predetermined time period.

18. The method of claim 17, wherein the auxiliary sensor is mechanically coupled to the user interface.

19. The method of claim 17, wherein the user interface in an activated state consumes more power than the user interface in a deactivated state.

20. The method of claim 17, wherein the user interface is a capacitive touch-based interface and the auxiliary sensor is not a capacitive sensor.
